(19) United States
(12) Patent Application Publication
(10) Pub. No.: US 2003/0173468 A1
(43) Pub. Date: Sep. 18, 2003

(54) Electrostatic 512kV rotator and/or oscillator propulsion system

(76) Inventor: David Joel Maker, Huntsville, AL (US)

Correspondence Address: David Maker, 7807 Hilton Dr., Huntsville, AL, 35802, US

(21) Appl. No.: 10/098,721

(22) Filed: Mar. 18, 2002

(51) Int. Cl. B64G 1/40

(52) U.S. Cl. 244/172

(57) ABSTRACT

Some recent experimental work(Pod,2001) implies that an electron cloud with external pulse from a superconductor(SC) can be generated at above approximately 500 kV. Also U.S. Pat. Nos. 593,138 and 4,661,747 imply that this can happen for nonSCs with rotating clouds of electrons above 500 kV. This can be theoretically explained simply by making General-Relativity(GR) algebraicly complete since the harmonic-coordinates are already physical (not gauge-coordinates) due to the Dirac-particle zitterbewegung oscillation. This UngaugedGR augmented by the Dirac-equation then results in the weak-field Einstein-equations being the Maxwells-equations which then imply a charge-source 8πke²/c² on the righthand side. One result of this Ungauged-GR is that you can do a radial-coordinate transformation of this E&M ke² Einstein-equation source to the coordinate system comoving with that sin hωt cosmological expansion resulting in (a added) classical-gravitational-source that can then be cancelled by creating an artificial-coordinate-transformation. A rotating disk at just above 512 kV appears to provide this annulment and so our propulsion-patent-details.

### CROSS-REFERENCE TO RELATED APPLICATIONS

Not Applicable

### STATEMENT REGARDING FEDERALLY SPONSORED RESEARCH OR DEVELOPMENT

There was no Federally sponsored research or development involved in this patent.

### BACKGROUND OF THE INVENTION

It is well known that there are four more metric coefficients than independent Einstein equations thus making general relativity “incomplete”. The solution has been to regard the Einstein equations as a gauged theory (Weinberg, 1972). For example the harmonic “gauge” is commonly used here in the weak field approximation giving R_{αα}≈□²h_{αα}=0≡k^{α}k_{α}=0 which imply the required four harmonic gauge (additional) equations

$${k}_{μ} {e}_{v}^{μ} = \frac{1}{2} {k}_{v} {e}_{μ}^{μ}$$

(Weinberg, 1972). But in the zitterbewegung oscillating system of a (Dirac equation) lepton this harmonic coordinate system is actually physical, not gauged, making the Einstein equations a ‘complete’, ungauged, theory in that case. But the augmentation of the Einstein equations by the Dirac equation introduces iterated Σk=0 empty space solutions to k^{α}k_{α}=0 which when Σk=0 is substituted into

$$\sum {k}_{μ} {e}_{v}^{μ} = \sum \frac{1}{2} {k}_{v} {e}_{μ}^{μ}$$

give new solutions to the Einstein equations: the Maxwell equations in the weak field limit (i.e., E&M). This implies that an E&M source (such as Zₒₒ=8πe²/mc²δ(0))≡8πkδ(0)) could be used in the Einstein equations instead of the standard gravitational source 8πGρ. And with this E&M source in the Einstein's equations the perturbations (to the Coulomb potential) coming out of the metric solutions to these new Einstein equations give the Lamb shift when applied to the 2,0,0 eigenfunction (so just one vertex QED, no renormalization) and the new Dirac equation S matrix gives the W and Z as resonances. Again this theory is not a gauge theory anymore (as we said) so 2k=r is in fact a singularity that cannot be gauge transformed away. Thus if the sources are 2k=r apart the clocks slow down, you have stability (i.e., the proton, note again that k∝e², not 8πGρ) but for r<k you have asymptotic freedom as in QCD. Finally in the end we can do a radial coordinate transformation (of Zₒₒ) to the coordinate system comoving with that cosmological expansion, the new additional term that results turns out to be that standard gravitational source. In a ungauged GR it is also possible to limit the number of implicit assumptions by allowing for fractalness within unobservable regions, within horizons. In combining the set of such Dirac equations, one for each fractal scale, one gets (using separability) a physical wavefunction which is a product of the time dependent Dirac eigenfunctions over fractal scales. The M+1 th low frequency Dirac eigenfunction gives nearly m=0, so a neutrino Hᵥψ=σ·ρᵥψ. From the fractalness the outside observer sees a e^{iωt} (ω=<H>/ [symbol] ) or sin ωt and so because of the square root in gₒₒ as the r goes through k the inside observer sees a sin ωt→sin hωt. Thus the inside observer sees exponential expansion. The sum of the Hs in this sin hωt must be zero since t is arbitrary so Hᵥ is the negative of Hₑ (electron) giving negative helicity σ·ρᵥ, thus giving a left handed doublet (electron and neutrino) with zero and nonzero mass. We can thus create the core of the standard model from the fractal assumption. Also here we found that the universe is then expanding with r=rₒ sin hωt. So if you do a radial coordinate transformation to the coordinate system comoving with the r=rₒ sin hωt expansion you get the old Zₒₒ plus a small additional source zₒₒ, the gravitational source.

### BRIEF SUMMARY OF THE INVENTION

Propulsion implications arise if we can cancel out (i.e., annul) the effect of that coordinate transformation. To do this we introduce a artificially created Kerr metric structure with the above 8πe²/mc² source(not the usual Gρ): same math as Kerr metric, new source. This artificial (E&M) Kerr metric as a quadratic structure and we can then find the solution from the quadratic formula. We find a term in the denominator of this result that is zero for a specific rotating electric field configuration thereby making an arbitrarily large contribution. We use this artificial metric to cancel the effect of the zₒₒdue to the coordinate system comoving with this expansion. In doing so we find a zₒₒ annulment term C^{o}/dt has a angular momentum in the numerator and a A=1-e2V/2 mc² in the denominator:

$$\frac{{C}^{0}}{ⅆ t} = {c}^{2} ( 2 \frac{V}{512 k} ) \frac{( v / c ) r {sin}^{2} θ ⅆ θ}{ⅆ t {c}^{2} [ 1 - V / 512 k ]} \qquad ( 1 )$$

For rotating charge there is a large (repulsive) gravitational propulsion effect for A=0 (=1-2 eV/2 mc²) so that V=512 kV if m is the electron mass. Also if the voltage is increased fast enough there will be a consecutive repelling and attractive propulsive pulse released.

So the two forms of the invention are a counterrotating set of capacitor plates at just above 512 kV with the other one being a rotating disc (with associated anode) given voltage provided by ramping up voltage through 512 kV up to 2 MV. The thrust is provided by the impulse coming off the anode.

Electrostatic 512 kV Rotar and/or Oscillator Propulsion System

Electrostatic—Uses high voltage produced by electrostatic charge generator.

512 kV—2 mc²/2 e=512,000 volts in the denominator of equation 1

Rotator—The rotation (that vr in equation 1) is provided by rotating capacitor plates or electrons in the vortices of a type II superconductor.

Oscillator—If just above 512 kV we must have non zero ω=dθ/dt oscillation. For a ‘ramping’ voltage (from 0→3 MV lets say) this oscillation is not necessary.

Propulsion System—For the ramping voltage a mg (mostly repulsive) pulse is sent out. Use Newton's 3 law to get reaction, or propulsive, force. For voltage at a just above a steady 512 kV there is no propulsion but there is still annulment, hovering.

### BRIEF DESCRIPTION OF THE FOUR DRAWINGS

FIG. A—Rotating Capacitors at just above 512 kV. Hovering.

FIG. B—Rotating Capacitors at just above 512 kV(details)

FIG. C—Ramped up voltage propulsion

### DETAILED DESCRIPTION OF THE INVENTION

In this type of General Relativity (GR) the 6 independent equations (with the 10 unknown gᵢⱼ s) are augmented by the 4 physical (not gauged) harmonic coordinate conditions of the Dirac equation zitterbewegung oscillation thereby showing that GR is algebraicly complete. Augmenting the Einstein equations with the Dirac equation makes the Einstein equations into the Maxwell equations (E&M) in the weak field limit thus implying that we should use a E&M source e²/mc² instead of the usual Gρ source on the right hand of the 0-0 component. There is a lot of evidence that this is correct. For example when you plug back into the Dirac equation the potentials you get from these new Einstein equations give you the Lamb shift without the need for higher order Feynman diagrams or renormalization and the new single vertex Dirac equation S matrix gives the W and Z as resonances. Note that we are merely noting that GR is complete anyway without adding any new assumptions.

No New Assumptions, in Fact One Less Assumption

In this section we do not implicitly assume that GR is referenced to only one particular scale. Out of the range of observability, in other words on the other side of either big or small horizons, there can be larger or smaller horizons all over again (fractalness). So there is one less assumption, that GR is referenced to only one particular scale. We simply drop this otherwise implicitly held assumption. So there is a Einstein equation curvature scalar R on each (N th) fractal scale and a Dirac equation ψ for each N th fractal scale. Here the N+1 (cosmological) fractal scale is about 10⁴⁰ times larger than the N th (electron) fractal scale. Rotation is nearly unobservable for the N+1 cosmological scale because of inertial frame dragging. Also we are using the Einstein equations so we impose general covariance on our lagrangians on each N th fractal scale. So we can write the lagrangian implied by the fractalness as a general covarient Dirac equation part plus an Einstein equation part summed over all fractal scales:

$${L}_{fractal} = {\sum }_{N = 1}^{∞} ( i ( {ψ}^{t} ) {N }^{γ} {μ ( \sqrt{{g}_{μ μ}} ψ , μ )}_{N} + {m ( {ψ}^{t} )}_{{N }^{ψ} N} + \sqrt{{g}_{N}} {R}_{N} + {( {L}_{Source} )}_{N} ) \qquad ( 1 )$$

Note that E=(dt/ds)√gₒₒ. Again the 0-0 source for the Nth fractal scale is 8πe²/mc² not Gρ.

Fractal Dirac Equation

The equation 1 lagrangian implies that the Dirac equation ψ s are also fractal with a ψ_{M} for each fractal scale M. So instead of just the single scale Dirac equation (Merzbacher, 1970):

[symbol]

ψ+i(1)βψ=0

we have a infinite succession of such equations:

( [symbol] ψ+i(1)βψ=0)_{M-1}, ( [symbol] ψ+i(1)βψ=0)_{M}, ( [symbol] ψ+i(1)βψ=0)_{M+1},

one for each fractal scale. Note from the lagrangian of equation 1 (with the Einstein equation component) the physical regions in which each of these equations apply are separated by a event horizon. The physical effects on the ambient metric begin with the M+1 scale equation if M+1 is the scale of our own cosmological ambient metric. Also this sequence of Dirac equations is equivalent to a single separable differential equation in the ψ_{M} s. Thus, as in all cases of separability, we can write a product function of the ambient ψ_{M} s:

$${\prod }_{N = M + 1}^{∞} {Ψ}_{N} = {Ψ}_{M + 1} \cdot {Ψ}_{M + 2} \cdot … = {Ψ}_{Physical}$$

But these Dirac eigenfunctions have the energies in their exponents (Ψ∝e^{iωt}=e^{I<H>t/z,902} ) in general we can also write (with k a column matrix):

$${Ψ}_{physical} = k exp ( ⅈ ( 1 / ℏ ) {\sum }_{N = M + 1}^{∞} {H}_{N} t ) = k exp ( ⅈ ( 1 / ℏ ) {H}_{{physical }^{t}} ) \qquad ( 2 )$$

We define the H s such that “t” here is the proper time for the observer in the M+1 th fractal scale to make Ψ^{t}Ψ physical for the M+1 th fractal scale. Also recall that Hψ=Eψ. The zitterbewegung oscillation also will have this r=rₒe^{iωt} dependence. dt/ds=1/gₒₒ so in the above Dirac equation

$$H ∝ ( ⅆ t / s ) √ {g}_{oo} ∝ 1 / √ {g}_{oo} SO : \\ ω ∝ H ∝ 1 / \sqrt{{g}_{00}} = 1 / \sqrt{1 - {k}_{H} / r} \qquad ( 3 )$$

as r gets less than k_{H} the square root becomes imaginary. So ω becomes imaginary. So if on the outside (i.e.,r>k_{H}) Ψ∝sin ωt (and zitterbewegung then sin μ≡sin ωt→sin(iωt)=sin hωt as you go to the inside (i.e., r<k_{H}). Thus for: Ψ and (zitterbewegung r=rₒe^{iΨt})

Both r and Ψ_{M}∝sin hωt inside, r and ω_{M}∝sin ωt outside (4)

So because of our observation point inside the horizon of all these ψ_{M} s those “i” s in the exponents in equation 2 will end up going away as in the sin hωt of equation 4. So the universe will accelerate in its expansion (since also r→rₒ sin hωt). Also because of the large M+1 th (cosmological) scale oscillation time T (in ω≡2π/T) the Dirac eigenfunction contribution to equation 2 is:

Zitterbewgung_{M+1}=ω_{M}+1≈0 (recall m∝ω_{M+1}) so then H_{M+1}≡σ·ρ (5)

So there is a neutrino contribution (with H_{M+1} eigenvalue Eᵥ) to the ambient physical wavefunction 2 from the M+1 th cosmological (huge!) source. Recall that the electron is itself the M th fractal scale source. So H_{M}→Hₑ gives eigenvalue Eₑ. Note that the Ψ_{physical} must be finite inside the source (Mth fractal scale) but for t=∞ it appears infinite using equation 3 in equation 2 i.e., Ψ_{physical} ∝ sin h(Ht/ [symbol] )=sin h((Σ_{M}H_{M})∞/ [symbol] ). So the exponent of equation 2 must have in it:

Σ_{M}H_{M=}0 (6)

so that the sum of the Hamiltonians over all fractal scales equals zero to make sure Ψ_{physical} is finite. So for example H_{M}+H_{M+1}=0 so that Eₑ+Eᵥ=0 giving Eᵥ=−Eₑ. But for a neutrino with the same Eᵥ that continues off into free space E_{M+1}ψ=Eᵥ ψ=σ·ρᵥ ψ∝γ⁵ ψ=helicityψ. So if Eₑ is positive then Eᵥ is negative (since Eᵥ=−Eₑ) so the neutrino helicity is negative (since it has the same sign as Eᵥ) and so the neutrino is left handed and (we have the negative sign in):

χ=½(1−γ5)ψ. (7)

In decay we have the electron moving in the opposite direction and so to conserve angular momentum we have a lefthanded ψ (with N and N−1 th fractal scale) lefthanded doublet in decay

L_{fractal}=(i(ψ^{t})_{L}γμ(\sqrt{gμμ}ψ, μ)_{L}+m(ψ^{t})_{L}ψ_{L}+\sqrt{g_{N}}R_{N}+(L_{Source})_{N}) (8)

Thus we can write our lagangian over just one fractal scale (instead over an infinite number as in equation (1) by just including a left handed zero mass component in ψ. This is our final lagrangian. This left handed Dirac lagrangian doublet (with one constituent being near zero mass) is at the core of the standard GSW electroweak model that has itself been at the core of theoretical particle physics for the last 30 years (Cottingham, 1998). The resulting single vertex Dirac S matrix gives the W and Z as resonances so it appears that the rest of the standard model (such as φ⁴ potential and covariant derivative consequences) is implied by this model as well! But this model is more general and so allows for the derivation of the standard model parameters and lagrangian terms as a special case.

Propulsion

Equation 4 [that sin hωt, written out as X^{α}≡x^{α}-λ_{M} sin h(ω_{H}t), also from equation 1 we have Zₒₒ=8πe²/2mc²] implies that to do the physics correctly we must do a radial coordinate transformation to the coordinate system comoving with the cosmological expansion giving:

$$\frac{\partial {x}^{0}}{\partial {X}^{α}} \frac{\partial {x}^{0}}{\partial {X}^{β}} Z α β = {Z}_{00}^{′} = {Z}_{00} + {z}_{00} \qquad ( 9 )$$

That zₒₒ turns out to be the classical gravitational source 8πGρ and we can actually derive G here.

We can then create a ARTIFICIAL coordinate transformation using changing E&M fields that cancels the physical effects of the equation 9 coordinate transformation that gave the gravity term z₀₀ in equation 9. In that case we could then cancel the effects of the gravitational constant G and so cancel out gravity and possibly inertia or even make G negative! This would certainly be an aid to propulsion technology. So putting in the effects of a annulling C₀₀ into that coordinate transformation X^{α}≡x^{α}-λ_{M} sin h(ω_{H}t) would modify this coordinate transformation to:

$$\frac{\partial {x}^{0}}{\partial {X}^{α}} \frac{\partial {x}^{0}}{\partial {X}^{β}} {Z }_{α β} = {Z}_{00}^{′} = {Z}_{00} + {z}_{00} - {C}_{00} where {C}_{00} = {z}_{00} . \qquad ( 10 )$$

So that X^{α}≡x^{α}-λ_{M} sin h(ω_{H}t)-λ_{M} sin h(ω_{H}t)=x^{α}+0. The zero signifies that our coordinate transformation effect has been annulled and therefore there would be no gravitational contribution zₒₒ in equation 9. Thus our goal is to derive an E&M configuration to artificially create this second

+λ_{M} sin h(ω_{M+1}t)≡C₀≡C_{O}cancellation=term. (11)

Thus the λ_{M} sin h(ω_{M+1}t) coordinate transformation term in equation (recall X^{α≡}x^{α}-λ_{M} sin h(ω_{H}t)) will cancel out and the mass zₒₒ term then will be canceled out in equation that coordination transformation. To get the artificial equation 11 cancellation term C^{o} we would like the most general (metric) E&M physical configuration available, which includes rotation. We then use it to derive X^{α}≡x^{α}−C^{α}. The most general metric available to do all this is the Kerr metric (Hawking, 1973):

$$ⅆ {s}^{2} = {ρ}^{2} ( \frac{ⅆ {r}^{2}}{Δ} + ⅆ {θ}^{2} ) + ( {r}^{2} + {a}^{2} ) {sin}^{2} θ ⅆ {φ}^{2} - {c}^{2} ⅆ {t}^{2} + \frac{2 m r}{{ρ}^{2}} {( {asin}^{2} θ ⅆ θ - c ⅆ t )}^{2} \qquad ( 12 )$$

ρ²(r,θ)≡r²+a² cos²θ, Δ(r)≡r²−2mr+a²

We will derive equation 11 for the case of the Kerr metric. For that purpose we take the Kerr metric to be a quadratic equation in dt (∝Cₒ/c) and find from equation 1 (our using our new E&M source) the ansatz

$${g}_{00} \approx 1 - \frac{2 eV ( x , t )}{2 {m}_{p} {c}^{2}}$$

from our new E&M source. We note that with the field magnitudes we will have the solution:

$$dt = \frac{- B \pm \sqrt{{B}^{2} - 4 AC}}{2 A} = \frac{- B}{2 A} \pm \sqrt{{( \frac{B}{2 A} )}^{2} - \frac{C}{A}} ( = {C}_{o} \text{/} c ) \qquad ( 13 )$$

so for smallest term (given the ± radical, note also 4AC=0 for A=0 and C is integrated over dt which is small relative to the dθ in the ‘B’ term):

$$cdt \text{/} {dt}_{o} = C ° \text{/} {dt}_{o} = cB \text{/} {Adt}_{o} = 2 cc \frac{4 m}{r} a {sin}^{2} θdθ \text{/} {dt}^{o} \text{/} 2 A = annullement$$

where A=c²−(2 m/r)c². With B carrying the angular momentum term. Notice though that if you varied 2 m/r just slightly around this value of 1 you would radically change gravitational mass since this “A” is everywhere in the denominator. mₚ→mₑ (electron mass) since here in macroscopic applications the electron motion will dominate. So we make 2 m/r=1 (then A will be nearly zero and so dt/dtₒ very large)

$$\frac{4 mr}{{ρ}^{2}} \approx ( \frac{4 {e}^{2}}{2 {m}_{e} {c}^{2} r} ) = 2 , ( - 4 eV / 2 {m}_{e} {c}^{2} = 2 V \text{/} 512 kV ) .$$

Here we choose two counterrotating concentric cylinders. Recall from elementary physics that the electric potential V=ke/r=kQ/r for a point source where in mks k=9×10⁹ Jm/C, e=1.6×10⁻¹⁹ C for a electron charge, Q(=e) is the total charge. Or just use V=kQ/r for the potential, which you can measure with a voltmeter, which is the appropriate quantity to use for these experiments. So in gₒₒ=1-ke²/(mc²r) you can write gₒₒ=1-2 eV/2 mc². Now for that denominator “A” term: A=1-2 ke²/2 mc²r=1-eV/mc² which equals zero for that singular case. Or (A=) 1-e2V/2 mc²=0. So rearranging and using m=electron mass (=9.11×10⁻³¹ kg), also c²=3×10⁸ squared=9×10¹⁶ m²/s²: so: V=mc²/e=9.11×10⁻³¹(9×10¹⁶)/1.6×10⁻¹⁹=512 kV. So that V(=ke/r)=2 mₑc²/2 e=512 kV=V. Recalling that here V =512 kV leads to A=c²−(2 m/r)c²≈0. So at 512 kV:

$$Co \text{/} dto = cB \text{/} Adto = 2 cc \frac{4 m}{r} a {sin}^{2} θdθ \text{/} {dt}^{o} \text{/} 2 A \approx \pm ∞ \qquad ( 14 )$$

depending on whether the (here tiny) “A” was positive or negative. Since the electrons constitute so small a fraction of the mass of the disc we see that for other charge on the disc not close to this 512 kV value there will be little effect. Thus by just varying the voltage above or below 512 kV you can make the disc containing the charge extremely heavier or extremely lighter. But to go up the disc has to be rotating rapidly so that the energy of rotation can be converted into potential energy to conserve energy: going up will mean a decreasing rotation rate of the disk for example. Thus essentially we can make discs fly up rapidly and levitate just by varying the Voltage on the plate.

Note here for B/A to be nonzero in equation 14 we have a≠0 so the plates have to be rotating. gₒₒ=1-2 eV/2 mc² is singular at the radius r at which V=512 kV so the usual way “clocks” slow down and particle positions remain stable (won't spark, holds together at surface which is near 512 kV, so stays in ball. The means of propulsion here are calibration of a prototype on the voltage of that negative dip in weight.

[image]

Prototype

We could build a prototype using the information gained from this experiment. Counterrotating discs (or free electrons at 512 kV moving rapidly between plates) will provide the propulsion. Energy is transferred from rotation to lift so that energy is conserved. The voltage at the lower weight spike (just above 512 kV) will be used for this purpose. According to equation 14 you can control the up or down force simply by controlling the voltage across rotating plates for which the voltage is just above 512 kV. Also the angular structure of the valence electron cloud in the material must change with time by using oscillating external fields for example. This is that dθ/dt in equation 14 above provided by the microwave source.

Related Patents and other Confirmational Experimental Results

U.S. Pat. No. 593,138 is for a type of transformer that above 400 kV (that voltage was recorded by later experimenters for this same apparatus) creates an “electro-radiant” event (cloud of electrons) that leaves perpendicular to the rotation direction of the current at above 400 kV. There is a accompanying monodirectional repulsive impulse that penetrates all materials. The inventor apparently did a lot of research verifying this result. Also U.S. Pat. No. 4,661,747 introduces a “conversion switching tube for inductive loads” that apparently created a similar pulse at a very high voltage. But note that our emphasis is on a static 512 kV rotator (with oscillation) that gives the mg lowering. This is not the same (pulse) concept as the previous two patents (but still uses equation 14) which merely give additional evidence that the device we are patenting is viable. In addition here we propose these results as a theoretical explanation of a Russian experiment recently completed and published Aug. 3, 2001 (Pod, 2001). Note that the rotational dependence and mg spiking with voltage work was done prior to August 3. In the Russian experiment as the voltage went through ˜500 kV (in a type II SC) a positive and negative gravity pulse was created (recall the above diagram implies this also). The pulse was proportional to the magnetic field put on the superconductor so that it was proportional to the vortex velocity just as the above effect was proportional to the capacitor rotational velocity. The above equation 14, that gives these results, was presented in the February STAIF 2001 (Maker, STAIF2001). These experimental results were presented in Aug. 3, 2001. The gravity pulse was created by voltage on a superconducting disc. An electron cloud in the form of a disk (instead of a spark! Only sparks occurred below 500 kV) left the disc and moved rapidly to the anode in a low vacuum chamber. The gravity pulse itself left the chamber and was detected by pendulums (which moved) on the other side of the anode from the disk outside the chamber. The movement was independent of the mass of the pendulum implying that it was a “gravity” pulse. Unattenuated pulses (within measurement error) were detected at 100 m from the SC.

Angular Momentum and dt

Recall from just above equation 14 that A=c²[1-2 m/r] with 2 m/r=2 e²/(2mₑc²r)=eV/(mₑc²)=V/512000, so also 4 m/r≈2 at 512 kV. Also in the classical Kerr solution a∝vr so angular momentum∝ma so area normalized Angular momentum=a=(v/c)r. So equation 14 can be rewritten as:

$$= \frac{{c}^{0}}{dt} = {c}^{2} ( 2 \frac{V}{512 k} ) \frac{( v \text{/} c ) r {sin}^{2} θdθ}{{dtc}^{2} [ 1 - V \text{/} 512 k ]} \qquad ( 15 )$$

The middle of the electron cloud is slightly closer to the anode so it accelerates along the z axis at a slightly greater rate than the outer portion creating a bulge in the middle (so θ different on the outside) that is directly proportional to the voltage traversed by the cloud. So the electron cloud is not flat when it reaches the anode, it has a slight convexity or even ‘cusp’ to it. Lets say the voltage reaches its final value when θ is near 13° (or for the other material 9.2°) so for the 13°=90°/convexity we have that convexity=7 and so in that case polar angle θ=2π[V_{f}−V/7V_{f}] we have the change dθ=d2π(V_{f-V)/}7V_{f}. Essentially you integrate from V=512 kV volts up to the final voltage v_{f}. I assumed a disk that had a bump height/radius large enough to cause a corresponding uncertainty in the voltage around that 512 kV value. So the “A” is not precisely zero and is displaced from zero by this small amount. I assumed that the upper part of the vortex (in the 7×10⁻⁷ m) contained the contributing rotating electrons. Take the thickness of the SC disk to be 8 mm=T and the radius to be 8 cm=r, the pulse rise dt=0.0001/2 sec (Pod,2001). I assumed that the electron velocity was the classical (e/m)rB=v=(1.6×10⁻¹⁹/9.11×10⁻³¹)(7×10⁻⁷)(0.9)=1.1×10⁵ m/s (not much different than the vortex velocity in the superconductor). So the radius normalized angular momentum is a=(v/c)r=(1.1×10⁵/3×10⁸)(0.08)=2.9×10⁻⁵

So equation 14 becomes:

$$\begin{matrix}\frac{{C}^{o}}{dt} = {c}^{2} \frac{4 m}{r} \frac{a {sin}^{2} θdθ}{{dtc}^{2} ( 1 - 2 m \text{/} r )} = \\ \frac{{C}^{o}}{dt} = {c}^{2} ( 2 \frac{V}{512 k} ) \frac{[ ( \frac{v}{3 {X10}^{8}} ) r ] {sin}^{2} ( \frac{2 π}{2 * 7} \frac{{V}_{f} - V}{{V}_{f}} )}{{dtc}^{2} ( 1 - V \text{/} 512 k )} ( \frac{π}{2 \times 7} ) \frac{dV}{{V}_{f}} \\ = {c}^{2} ( 2 \frac{V}{512 k} ) \frac{( ( v \text{/} c ) r ) {cos}^{2} ( \frac{π}{2 \times 7} \frac{V}{{V}_{f}} )}{{dtc}^{2} ( 1 - V \text{/} 512 k )} \frac{π}{2 \times 7} \frac{dV}{{V}_{f}} ( \frac{2}{512 k} ) \frac{2.9 \times {10}^{- 15} \times π}{. ( .0001 \text{/} 2 ) {V}_{f} 2 * 7} [ \frac{V}{( 1 - V \text{/} 512 k )} ] {cos}^{2} ( \frac{π}{2 \times 7} \frac{V}{{V}_{f}} ) dV \\ \frac{{C}^{o}}{dt} = 5.14 \times {10}^{- 7} [ ( \frac{V}{{V}_{f}} ) \frac{{cos}^{2} ( ( π \text{/} 2 * 7 ) ( V \text{/} {V}_{f} ) )}{1 - V \text{/} 512 k} ] dV\end{matrix} \qquad ( 16 )$$

We next integrate this equation. Define

$$Integral = 5.14 \times {10}^{- 7} {\int }_{512 k - Δ}^{{V}_{f}} ( \frac{V}{{V}_{f}} ) \frac{{cos}^{2} ( \frac{π}{2 * 7} \frac{V}{{V}_{f}} )}{( 1 - V \text{/} 512 k )} ⅆ V ≡ Ve \qquad ( 17 )$$

Close to the 512 kV singularity the V is not infinitely well defined because of the SC surface irregularities. Also this integral was taken numerically and Pod(2001) claimed that the pulse started at 500 kV instead of 512 kV so we take Δ=12 kV. Thus for 500<V<512 we use the ve value at 500 kV and for 520>V>512 ve has the value at 520 kV.

Comparison to Pendulum Tests

A pendulum in a evacuated chamber was placed on the line connecting the anode and the cathode but on the other side of the anode from the cathode. It was placed at various distances from the cathode. A repulsive pendulum movement was observed that was independent of the type of material or the mass the pendulum was constructed of. The pendulum displacement was measured (and so the final height) as a function of the applied voltage V at the cathode. To help determine the nature of the voltage v we look toward the data presented in the aforementioned impulse experiments. Recall that ve is the voltage integral to V_{f}. in equation 17. So here the acceleration is given by

$$a ( c ) \approx \frac{ve}{t} \qquad ( 18 )$$

where again t is the impulse time given by Pod-Mod pulse rise time of t≈0.0001/2 sec. The velocity v applied to the pendulum mass by the impulse is given by

ve=\sqrt{2gh} (19)

So that

$$\frac{{( ve )}^{2}}{2 g} = h \qquad ( 20 )$$

This is the equation used to calculate the pendulum height as a function of Voltage applied to the SC.

Putting the integral of equation 17 into equation 20 we get for individual final heights (using a numerical integration fortran code) as a function of voltage and plotting the results together with the experimental (Pod,2001):

[image]

Acceleration

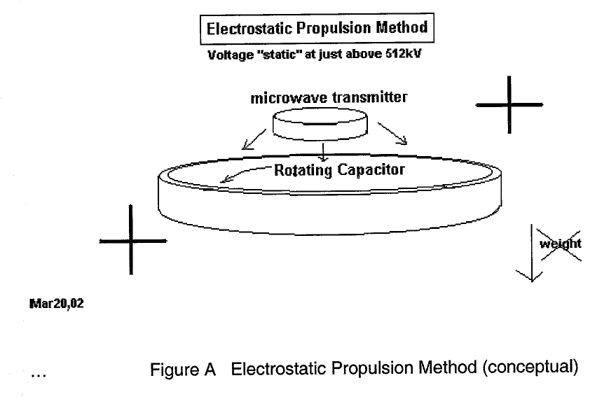

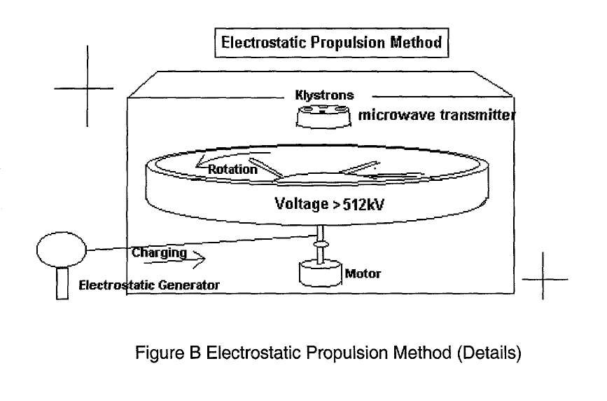

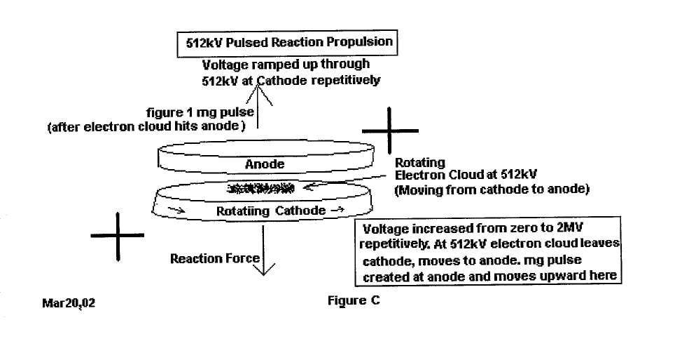

Putting the integral of equation 17 into equation 18 (with impulse rise time=t=0.0001/2 sec) we get the following (theoretical) pendulum accelerations (FIG. 3) at the given final voltages and cusp angles. Note the negative (attractive) spike near 500 kV, with above 512 kV being positive (antigravity). So a smaller positive gravity impulse is seen and then the larger antigravity impulse at the higher voltages. Pod noted accelerations on the order of 1000 gs. Note also the pod (2001) microphone results (down and up dips in pressure) that can be inferred to be the results of the up and down spike results predicted above.

[image]

References

Bjorken, Drell, Relativistic Quantum Mechanics, McGraw-Hill, (1964).

Cottingham W. N., An Introduction to the Standard Model of Particle Physics, 1998, pp.112.

Feynman, R. P., Quantum Electrodynamics, Benjamin, N.Y., (1961).

Goldstein, Herbert, Classical Mechanics, 2nd Ed, Addison Welsey, 1980 pp.576.

Graves, J. C,.Brill, D. R., “Oscillating Character of an Ideal Charged Wormhole,” Phys.Rev 120 1507-17 , (1962).

Halzen F, A. D. Martin, Quarks and Leptons, Wiley, (1984).

Hawking, S, Large Scale Structure of Space-Time, Cambridge University Press, (1973) pp.169.

Kursunglu B. N. and A. P. Wigner, Reminiscences about a Great Physicist: P.A.M. Dirac, Cambridge Univ. Press, Cambridge, (1987).

Liboff, Richard, Quantum Mechanics, 2nd ed., Addison-Wesley, (1991), pp.202.

Maker, David, Quantum Physics and Fractal Space Time, Chaos, Solitons, Fractals, Vol.10, No.1, (1999).

Maker, David, “Propulsion Implications of a New Source for the Einstein Equations,” in proceedings of Space Technology and International Forum (STAIF 2001), edited by M. El-Genk, AIP Proceeding 552, AIP, NY, 2001, pp. 618-629.

Merzbachier, Quantum Mechanics, 2nd Edition, 1970 P.596, equations 24.21, 24.24.

Podlkletnov,(Pod) arXiv:physics/o108005, Aug 3, 2001.

Sokolnikof, Tensor Analysis, Wiley, (1964).

Weinberg,S., Relativity and Cosmology, Wiley, (1972).

1. We claim this invention provides a new form of electrostatic propulsion and furthermore claim that there is adequate experimental and theoretical evidence that it will work. The claim is that a rapid spherical rotator at just above 512 kV in a low amplitude oscillatory electric field will experience lower mg.

2. A ramping up of the voltage through 512 kV will give an impulse out the back after the electron cloud from the cathode strikes an object such as anode. Also we claim that there is adequate experimental and theoretical evidence that this will work. The theory behind claims 1 and 2 is the same.
